(19) United States
(12) Patent Application Publication
(10) Pub. No.: US 2017/0368472 A1
(43) Pub. Date: Dec. 28, 2017

(54) LOW PRESSURE MECHANICAL VAPOR RECOMPRESSION SYSTEM AND METHOD

(71) Applicant: Darrell FORD, Spruce Grove (CA)

(72) Inventor: Darrell FORD, Spruce Grove (CA)

(21) Appl. No.: 15/632,160

(22) Filed: Jun. 23, 2017

Related U.S. Application Data
(60) Provisional application No. 62/353,754, filed on Jun. 23, 2016.

(51) Int. Cl. B01D 1/28; B01D 1/00

(52) U.S. Cl. CPC B01D 1/2856; B01D 1/2893; B01D 1/0058; B01D 1/2881; B01D 1/289

(57) ABSTRACT

A mechanical vapor recompression evaporation system wherein a fluid stream from a fluid source is compressed in a compressor and used to transfer heat to an incoming stream of liquid, the system comprising a combustion engine mechanically coupled to the compressor to drive the compressor, and having a combustion exhaust gas conduit; and a mixing chamber or heat exchanger in fluid communication with the combustion exhaust gas conduit and the fluid to transfer heat from the hot exhaust gas to the fluid stream.

### FIELD OF THE INVENTION

The present invention relates to a low pressure vapor recompression method that greatly decreases the amount of thermal and mechanical energy, as well as reducing the complexity and cost of equipment, needed to mechanically re-compress steam or other gaseous vapors. Re-compression is a known requirement of the mechanical vapor recompression (MVR) evaporation process. The re-compression employed in an MVR evaporation system is needed to increase the temperature of the working vapor via an increase in pressure of the working vapor to levels adequate to supply the necessary temperature delta's needed to transfer the latent heat energy from the working fluid vapor into a contaminated liquid stream entering on the inlet side of the process and typically separated from the working vapor via plates or some form of heat exchangers. The contaminated influent absorbs the latent heat energy from the recompressed working fluid through the heat exchanger walls and is effectively evaporated or ‘flashed’. This phase change to vapor from liquid of the target fluid serves to create a density sort between undesirable contaminants (which do not experience phase change to vapor until much higher temperatures and therefor remain in solid phase) allowing for their removal effectively cleaning the fluid. The cleaned fluid is then condensed and separated from the undesirable solids and finally exits the process allowing it to be beneficially reused in the global eco-system. More particularly the present invention deals with cleaning/recycling of waste water called ‘produced water’ being collected as a by-product of worldwide oil, gas and coal-bed methane production.

### BACKGROUND OF THE INVENTION

Water is a precious resource. Fresh water scarcity and increasing demand are leading to new initiatives in the recycling and reuse of water for industrial purposes, in particular for use in the oil and gas industry.

The oil and gas industry consumes multiple millions of cubic meters of fresh water every year. This clean water is used directly in exploration, formation modification/pre-production preparation (well completion) as well as in ongoing formation maintenance of the oil, gas or coalbed methane production—such as for example fracking. On the other hand, the same industry produces millions of cubic meters of water that is contaminated and requires costly treatment and disposal. The industry consumes a finite resource such as fresh water and at the same time produces a equally large volume of contaminated water that is becoming increasingly difficult to deal with in an environmentally responsible or economically feasible way. Numerous technologies have developed to attempt to correct this imbalance. One of the methods commonly employed in the industry to clean various fluids of undesirable contaminants is a process called Mechanical Vapor Recompression Evaporation (MVRE). Mechanical vapor recompression evaporation is an energy recovery process which involves taking vapor (usually water vapor) at or a little above atmospheric pressure and adding energy to it by performing mechanical compression on the vapor. The result is a smaller volume of vapor, at a higher temperature and pressure, which can be used to exchange energy (recovering latent heat energy) into an incoming stream of fluid effectively evaporating the incoming stream of fluid. This recovered latent heat energy is typically wasted in a simple evaporation process and with the use of an MVR this energy can be recovered and used in the evaporation process.

Current MVR systems, although more efficient than the simple evaporation and condensation cycle, do require significant amounts of additional mechanical energy input to drive the compression equipment. The amount of additional energy required is dictated by the target steam temperatures necessary to provide an adequate temperature gradient/delta in order to effect the heat energy transfer from the compressed working fluid through a heat exchanger wall and into the incoming contaminated fluid resulting in the evaporation of this fluid, while maintaining a reasonable surface area requirement for the heat exchangers. The compression ratio in a common MVR unit usually must reach pressures of around 10-15 psig with a corresponding working fluid/steam temperatures of around 245° F.-250° F. These systems typically consume approximate 80-100 btu per lb of water evaporated with a simple evaporation cycle requiring around 1000 btu per lb of water evaporated.

### SUMMARY OF THE INVENTION

The present invention provides a mechanical vapor recompression evaporation system wherein a fluid stream from a fluid source is compressed in a compressor and used to transfer heat to an incoming stream of liquid, the system comprising a combustion engine mechanically coupled to the compressor to drive the compressor, and having a combustion exhaust gas conduit, and a mixing chamber or heat exchanger in fluid communication with the combustion exhaust gas conduit and the fluid to transfer heat from the hot exhaust gas to the fluid stream.

In some aspects the present invention provides a mechanical vapor recompression evaporation system wherein a fluid stream from a fluid source is compressed in a compressor and used to transfer heat to an incoming stream of liquid, the system comprising: a combustion engine mechanically coupled to the compressor to drive the compressor, and having a combustion exhaust gas conduit; and a mixing chamber in fluid communication with the combustion exhaust gas conduit and the fluid to mix hot exhaust gas from the combustion engine with the fluid stream.

In some embodiments, the mixing chamber may be upstream of the compressor. In some embodiments, the fluid stream entering the mixing chamber may be a vapor stream from an evaporator. In some embodiments, the mixed exhaust gas/vapor stream downstream of the compressor may be returned to the evaporator.

In some aspects, the present invention provides a mechanical vapor recompression evaporation system wherein a fluid stream from a fluid source is compressed in a compressor and used to transfer heat to an incoming stream of liquid, the system comprising: a combustion engine mechanically coupled to the compressor to drive the compressor, and having a combustion exhaust gas conduit; and a heat exchanger in fluid communication with the combustion exhaust gas conduit on a first side and the fluid stream on a second side to transfer heat from hot exhaust gas from the combustion engine to the fluid stream.

In some embodiments, the heat exchanger may be upstream of the compressor. In some embodiments, the fluid stream entering the heat exchanger may be a vapor stream from an evaporator. In some embodiments, the vapor stream downstream of the compressor may be returned to the evaporator.

The present invention greatly reduces the pressures required to reach the necessary temperatures; allows for the use of significantly less expensive compression equipment in the form of centrifugal fans as opposed to PD blowers such as those sold by Dresser Roots; requires significantly less input energy to reach the required lower pressures and is also able to supply higher working fluid temperatures resulting in the opportunity to employ smaller heat exchange areas and therefore a reduction in the overall cost of equipment. The system operates at pressures between 1-5 PSIG and temperatures >250° F. or 300° F. and requires less than 50 btu per lb of water evaporated. This is effectively a ˜40-50% increase in efficiency.

The invention comprises of an improved system and method of achieving the recompression of any vapor stream to the required pressures and corresponding temperatures necessary to effectively transfer the latent heat energy via a heat exchanger from the compressed working fluid into a target contaminated fluid. This low pressure mechanical vapor recompression operates at greatly reduced pressures effectively reducing the amount of mechanical and thermal energy required to reach the required temperatures in the cycle.

The foregoing was intended as a broad summary only and of only some of the aspects of the invention. It was not intended to define the limits or requirements of the invention. Other aspects of the invention will be appreciated by reference to the detailed description of the preferred embodiment and to the claims.

### BRIEF DESCRIPTION OF THE DRAWINGS

These and other features of the invention will become more apparent from the following description in which reference is made to the appended drawings and wherein:

FIG. 1 is a process flow diagram according to the present invention;

FIG. 2 is a process flow diagram according to another embodiment of the present invention.

### DETAILED DESCRIPTION

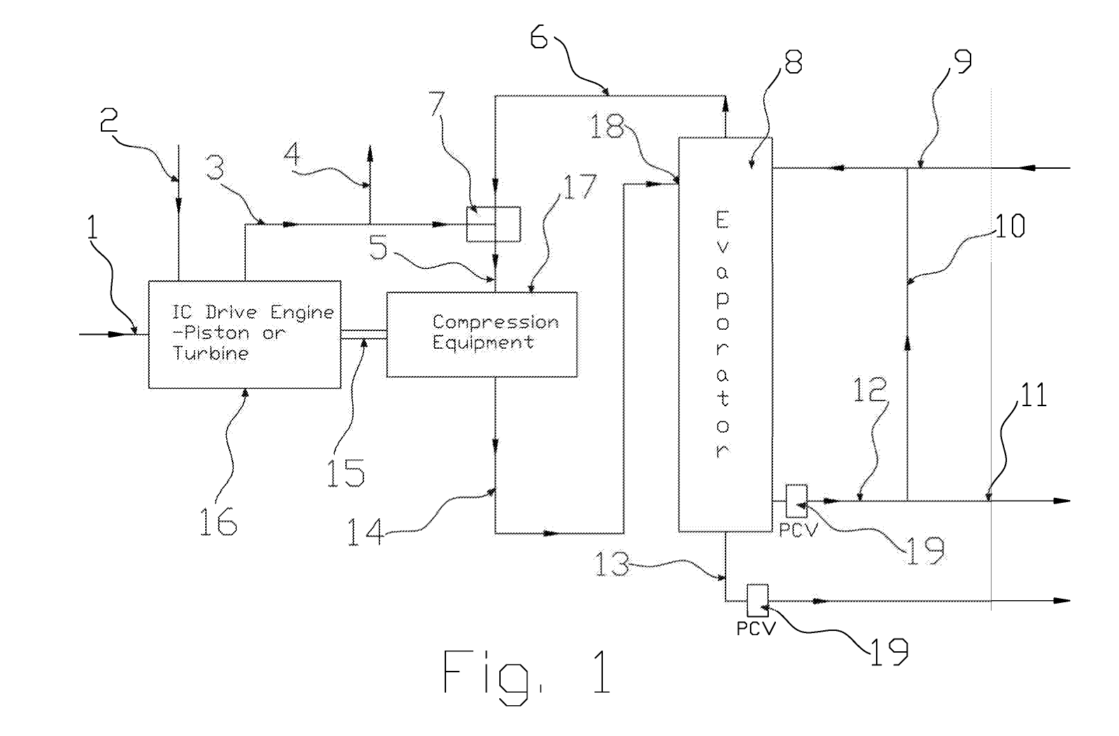

A preferred embodiment of an improved efficiency low pressure mechanical vapor recompression system for use in recycling contaminated fluids is shown in FIG. 1.

The system generally comprises a fan/compressor 17 specifically configured to work with steam or other vapors, such as for example a commercially available purpose built low pressure/high volume mechanically driven fan/compressors. An example of such fan/compressor is one sold as a Pressure Blower by Twin City Fans. Other suitable fans/compressors may be employed as would be apparent to the skilled reader, including but not limited to high pressure fans, rotary or piston compressors.

The fan/compressor 17 is mechanically coupled and thereby driven by a combustion engine 16, such as an internal combustion reciprocating engine or a rotary turbine engine. The engine 16 has a source of air 2 and fuel 1 for the combustion reaction. The combustion exhaust gas 3 exits the engine 16 via a conduit and may be expelled to the atmosphere via conduit 4, but preferably is conveyed to a mix chamber 7 that is fluidly coupled to an evaporator 8 and the fan/compressor 17.

The fan/compressor 17 is fluidly coupled to an evaporator 8, which is well known technology, and may be a type referred to as falling film, tube and shell, as well as others that would be apparent to the skilled reader. The fan/compressor 17 pulls a slight vacuum on the inlet side of the evaporator 8 thereby creating a vacuum condition in the evaporator 8, which in turn draws produced steam into the inlet of the fan/compressor via conduit 6. As a result of the consequent vacuum condition in the evaporator chamber, the waste liquid (from inflow 9) will evaporate at lower temperatures—in the case of water, likely in the range of 200° F. to 210° F. depending on the vacuum conditions and type of fluid being evaporated. As the steam passes through the mix chamber 7, the high temperature exhaust 3 coming from the engine 16 is mixed with the steam at mixing chamber 7 thereby adding significant thermal energy to the steam/exhaust mixture—a mixture that would be at approximately a 10:1 ratio with 10 parts being steam or working fluid vapor and 1 part being flue-gas from the engine.

The vapor/exhaust mixture enters the fan/compressor 17 via conduit 5 where it is compressed to a pressure adequate to increase the steam temperature to between 220° F. and 350° F. Due to the addition of significant thermal energy coming from the high temperature exhaust flue-gas 3 (exhaust temps are in the range of 700-1200° F.), the amount of compression work needed to raise the steam/flue-gas mixture to the exchanger inlet target temperatures is greatly reduced thereby reducing the amount of mechanical work required to drive the fan/compressor 17.

The now re-compressed ‘hot’ steam/flue-gas mixture is directed via conduit 14 to the steam inlet of the evaporator system 8 at inlet 18. Heat transfer takes place within the evaporator 8 causing the inlet fluid entering the system via conduit 9 and into the evaporator to experience a phase change to vapor and the re-compressed steam/flue-gas mixture to cool and condense into a cooled liquid/flue-gas mixture. Due to the positive pressure in the evaporator, the re-compressed steam/flue gas will condense at higher temperatures than at normal atmospheric pressure. The cooled flue gas and concentrated brine (or solids in the case of a ‘Dry’ system) exits the evaporator via conduit 13 for further separation, and the clean condensate exits the evaporator via conduit 12. The cleaned liquid can be directed out of the cycle via conduit 11 or it can be re-directed to the inlet fluid 9 for a blending step via conduit 10. Sufficient back pressure is held on the evaporator via pressure control valves 19.

System power required to drive the fan/compressors as well as other ancillary processes of the system is preferably provided by way of a standard engine 16 such as an internal combustion reciprocating engine or a rotary turbine engine, depending on the configuration and application. Fuels for the internal combustion reciprocating engine or the rotary turbine engine can be diesel, natural gas, propane, producer gas, syn-gas or other suitable fuel. The high temperature exhaust flue-gas (approximately 40-50% of the incoming fuel energy) being directed through conduit 3 to the blend chamber 7 where it is blended with the steam resulting in a increase in temperature of this mixture as described above.

Under normal operating conditions it is anticipated that the system will run as follows: Inlet—slight negative pressure and steam coming off at 200-215° F. Outlet from fan/compressor and inlet to the heat exchanger or evaporator will be approximately 1-10 psig and 220-350° F.

Preferably all fluids coming into the cycle via conduit 9 have been adequately processed to remove total suspended solids and other organics, and in cases where the inlet fluids require de-oiling or de-greasing, the system will employ standard dissolved air flotation technology or filtration technology appropriate for the type and amount of oil and grease to be removed. In some cases, the oils/grease may be non-flowing and will require the use of skimmers or other devices widely know in order to remove the oil and grease.

Referring to Table 1, there is shown a table detailing a theoretical mass flow and energy balance of a low pressure mechanical vapor recompression unit employing a ˜130 KW drive engine. The calculation displays the necessary variables needed to mathematically demonstrate the amount of input energy required to evaporate one lb of water using the invention detailed. The energy required ˜45 btu/lb of water/brine processes when that brine has a TDS of 200,000 ppm (20% dissolved solids) at the inlet to the evaporator.

TABLE 1
theoretical mass flow and energy balance of a low pressure mechanical
vapor recompression unit employing a ~130 KW drive engine

| Low Pressure Mechanical Vapor Recompression Calcs | |
|---|---|
| M3 per Hr Processed (20% TDS Content In) | 12 |
| M3 in 24 hrs Processed (20% TDS Content In) | 250 |
| Lbs steam min in cycle | 318.74 |
| Lbs steam per hr in cyle | 19,124.22 |
| Lbs steam per 24 hrs in cycle | 458,981.23 |
| Thermal Output to Evaporation_BTU minute | 358,667 |
| Thermal Output to Evaporation_BTU hr | 21,400.000 |
| Density of Steam @ Inlet to Blower - 210 F. | 0.034842 |
| Internal Energy @ Inlet to Blower - 210 F. | 1,077.7 |
| Density of Steam @ Blend Inlet - 265 F. | 0.032619 |
| Internal Energy @ Blend Inlet - 265 F. | 1,098.0 |
| Density of Steam @ Evap Inlet - 324 F. | 0.037252 |
| Internal Energy @ Evap Inlet - 324 F. | 1,119.0 |
| BUT Per Lb added from Exhaust Flow | 23.94 |
| BUT Per Lb added from Shaft Work | 20.95 |
| ACFM @ Inlet to Fan @ 210 F. | 9.148 |
| ACFM @ Blend Inlet @ 285 F. | 10,749 |
| ACFM @ Fan Outlet (Flue-Gas Included) @324 F. | 9.489 |
| Fan/Drive Engine Calcs | |
| ACFM at Inlet to Recompression Fan | 10,749 |
| BHP at Flow and Temp | 173.5 |
| IC Engine Output Required - KW | 129.2 |
| BUT Input - Thermal Total | 1.259,110 |
| Conversion to Mechanical EFF | 36% |
| BUT Output - Mechanical to Shaft | 440,689 |
| BUT Waste to Exhaust - 40% | 503,644 |
| BUT per Lb Brine Processed | 45.72 |

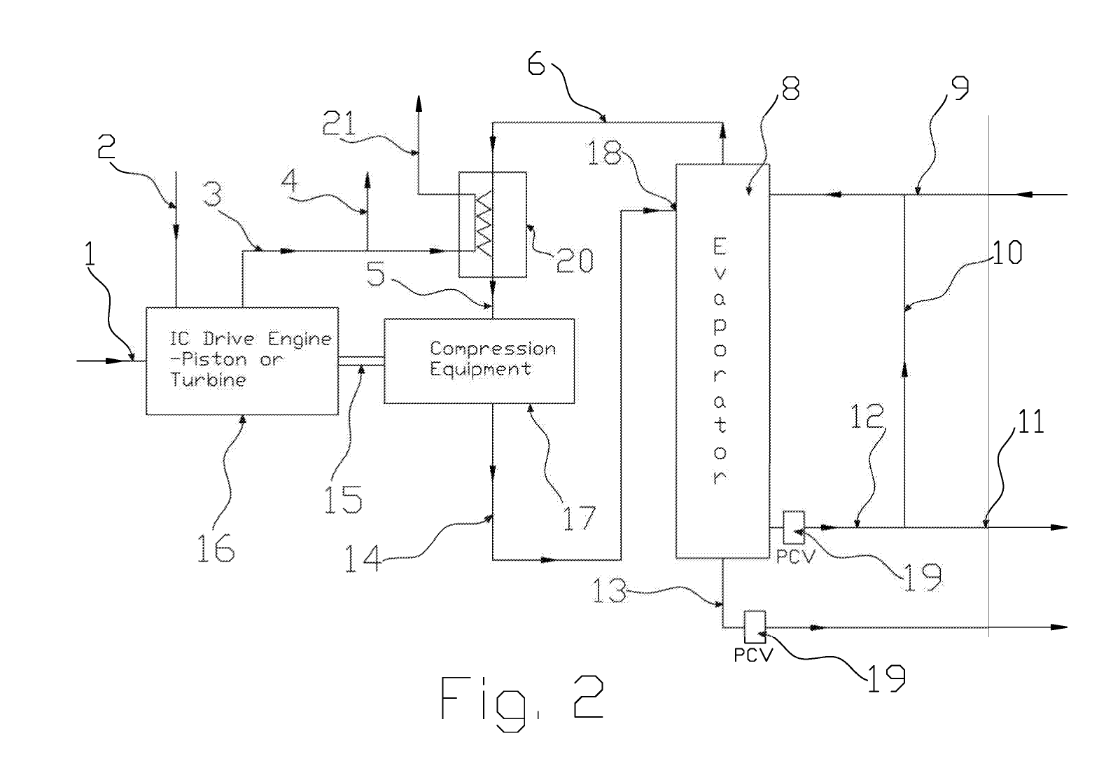

Referring to FIG. 2, there is shown another embodiment of the present invention having components as described with reference to FIG. 1 but with a heat exchanger 20 in place of the mix chamber 7. Hence the exhaust gas 3 passes through the heat exchanger 20 and transfers its heat to the produced steam 6 that passes through the other side of the heat exchanger 20. Thus the exhaust gas and the produced steam do not mix, but heat from the exhaust gas is nevertheless transferred to the produced steam 6 prior to it moving into the fan/compressor 17. The remainder of the system and method is as described above with reference to FIG. 1.

The fluid stream entering the inlet to the mixing chamber may be in a completely vapor phase or may be partially liquid and partially gas. In conventional MVR processes any entrained liquid droplets would be preferably removed before entering the inlet to the compressor to avoid damage to the blades, rotating lobes or the piston and valves. This would be typically accomplished by employing some type of liquid-vapor separator equipment upstream of the compressor thereby removing any liquid component in the fluid stream prior to the compressor inlet. In the present invention, by introducing the high grade waste heat from the heat engine before the inlet to the compressor via direct injection of the engine flue gas or by utilizing a heat exchanger, entrained liquid droplets would effectively be removed as they experience phase change to a vapor before entering the compressor inlet thereby eliminating the need for the use of liquid-vapor separator type equipment in the system.

While the embodiments described utilize the additional thermal energy of the exhaust gas from the engine upstream of the compressor, via a direct mixing of engine flue-gas and the incoming fluid from the vapor source in a mixing chamber, or via transferring the heat energy from the engine flue gas through some form of heat exchanger into the incoming vapor stream, it is nevertheless contemplated that the exhaust gas may be utilized on the downstream side of the compressor either directly or indirectly as above. This would be desirable in cases where the fluid to be compressed is delivered to the inlet of the compressor at elevated temperatures and to avoid overheating the compressor all additional heat energy would be added after the outlet of the compressor.

While the above embodiments have been described primarily in a system that handles water, it may be adapted and used in bringing about phase changes for other fluids.

It will be appreciated by those skilled in the art that the preferred and alternative embodiments have been described in some detail but that certain modifications may be practiced without departing from the principles of the invention.

What is claimed is:

1. A mechanical vapor recompression evaporation system wherein a fluid stream from a fluid source is compressed in a compressor and used to transfer heat to an incoming stream of liquid, the system comprising:
a combustion engine mechanically coupled to the compressor to drive the compressor, and having a combustion exhaust gas conduit; and
a mixing chamber in fluid communication with the combustion exhaust gas conduit and the fluid to mix hot exhaust gas from the combustion engine with the fluid stream.

2. The system as claimed in claim 1 wherein the mixing chamber is upstream of the compressor.

3. The system as claimed in claim 2 where in the fluid stream entering the mixing chamber is a vapor stream from an evaporator.

4. The system as claimed in claim 3 wherein the mixed exhaust gas/vapor stream downstream of the compressor is returned to the evaporator.

5. A mechanical vapor recompression evaporation system wherein a fluid stream from a fluid source is compressed in a compressor and used to transfer heat to an incoming stream of liquid, the system comprising:
a combustion engine mechanically coupled to the compressor to drive the compressor, and having a combustion exhaust gas conduit; and
a heat exchanger in fluid communication with the combustion exhaust gas conduit on a first side and the fluid stream on a second side to transfer heat from hot exhaust gas from the combustion engine to the fluid stream.

6. The system as claimed in claim 5 wherein the heat exchanger is upstream of the compressor.

7. The system as claimed in claim 6 wherein the fluid stream entering the heat exchanger is a vapor stream from an evaporator.

8. The system as claimed in claim 7 wherein the vapor stream downstream of the compressor is returned to the evaporator.
